(19) United States
(12) Patent Application Publication
(10) Pub. No.: US 2013/0139638 A1
(43) Pub. Date: Jun. 6, 2013

(54) Actuating cable for cycle

(71) Applicant: Chang Hui Lin, Chang Hua Hsien (TW)

(72) Inventor: Chang Hui Lin, Chang Hua Hsien (TW)

(21) Appl. No.: 13/373,806

(22) Filed: Dec. 1, 2011

(51) Int. Cl. F16C 1/20

(52) U.S. Cl. 74/502.5

(57) ABSTRACT

An actuating cable includes an inner bushing, a tubular cushioning member, and a number of longitudinal members disposed and engaged between the cushioning member and the inner bushing, the longitudinal members include one or more metal elements, and one or more non-metal elements arrangeable in different positions for adjusting the arrangement and/or the strength and/or flexibility and/or stiffness of the actuating cable and for suitably actuating or operating the brake devices or the transmission devices of the cycle. The metal element is selected from a steel element, an iron element, an aluminum element, a magnesium and aluminum alloy element, and a titanic alloy element The non-metal element is selected from a fiber element, and a plastic element.

### BACKGROUND OF THE INVENTION

1. Field of the Invention

The present invention relates to an actuating or operative or pulling cable for a cycle, such as a bicycle, a tricycle, a motor cycle, a unicycle, etc., and more particularly to an actuating or operative or pulling cable including an adjustable structure for adjusting the arrangement and/or the strength and/or flexibility and/or stiffness of the actuating cable and for suitably actuating or operating the brake devices or the transmission devices of the cycle.

2. Description of the Prior Art

Typical cycles, such as bicycles, tricycles, motor cycles, unicycles, etc. each comprise one or more facilities or devices, such as the brake devices or the transmission devices of the cycles that are required to be actuated or operated with one or more actuating or operative or pulling cables.

For example, U.S. Pat. No. 3,765,511 to Toyomasu, U.S. Pat. No. 3,997,033 to Bulmer, and U.S. Pat. No. 6,340,074 to Lumpkin et al. disclose several of the typical brake devices of the cycles each comprising one or more actuating or operative or pulling cables attached or mounted or secured or coupled to the brake devices for actuating or operating the brake devices of the cycles.

Normally, the actuating or operative or pulling cables of the typical brake devices of the cycles include a single inner wire slidably received or engaged in the outer sheath or cover or tube. However, the arrangement and/or the strength and/or flexibility and/or stiffness of the actuating cable may not be adjusted to fit different cycles.

U.S. Pat. No. 4,089,231 to Segawa, U.S. Pat. No. 4,299,581 to Korosue, and U.S. Pat. No. 4,501,575 to Lapeyre disclose several other typical transmission devices of the cycles each comprising one or more actuating or operative or pulling cables attached or mounted or secured or coupled to the transmission devices for actuating or operating the transmission devices of the cycles.

However, similarly, the actuating or operative or pulling cables of the typical transmission devices of the cycles also include a single inner wire slidably received or engaged in the outer sheath or cover or tube, and the arrangement and/or the strength and/or flexibility and/or stiffness of the actuating cable may not be adjusted to fit different cycles.

The present invention has arisen to mitigate and/or obviate the afore-described disadvantages of the conventional actuating or operative or pulling cables of the cycles.

### SUMMARY OF THE INVENTION

The primary objective of the present invention is to provide an actuating or operative or pulling cable including an adjustable structure for adjusting the arrangement and/or the strength and/or flexibility and/or stiffness of the actuating cable and for suitably actuating or operating the brake devices or the transmission devices of the cycle.

In accordance with one aspect of the invention, there is provided an actuating cable comprising an inner bushing, a tubular cushioning member, and a number of longitudinal members disposed and engaged between the cushioning member and the inner bushing, the longitudinal members including at least one metal element, and at least one non-metal element arrangeable in different positions.

The metal element is selected from a steel element, an iron element, an aluminum element, a magnesium and aluminum alloy element, and a titanic alloy element The non-metal element is selected from a fiber element, and a plastic element. The fiber element is selected from a glass fiber, and a carbon fiber.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a partial perspective view of an actuating or operative or pulling cable in accordance with the present invention for the cycles, in which a portion of the actuating or operative or pulling cable has been cut off for showing the inner structure of the actuating or operative or pulling cable;

FIG. 2 is a cross sectional view of the actuating cable, taken along lines 2-2 of FIG. 1;

FIG. 3 is a partial cross sectional view of the actuating or operative or pulling cable; and

FIG. 4 is another partial cross sectional view similar to FIG. 3, illustrating the other arrangement of the actuating or operative or pulling cable for the cycles.

### DETAILED DESCRIPTION OF THE PREFERRED EMBODIMENT

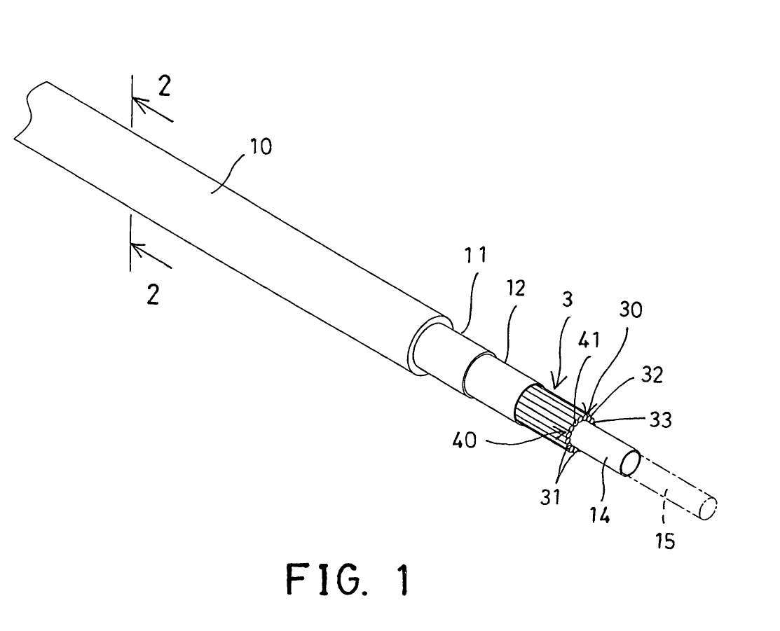

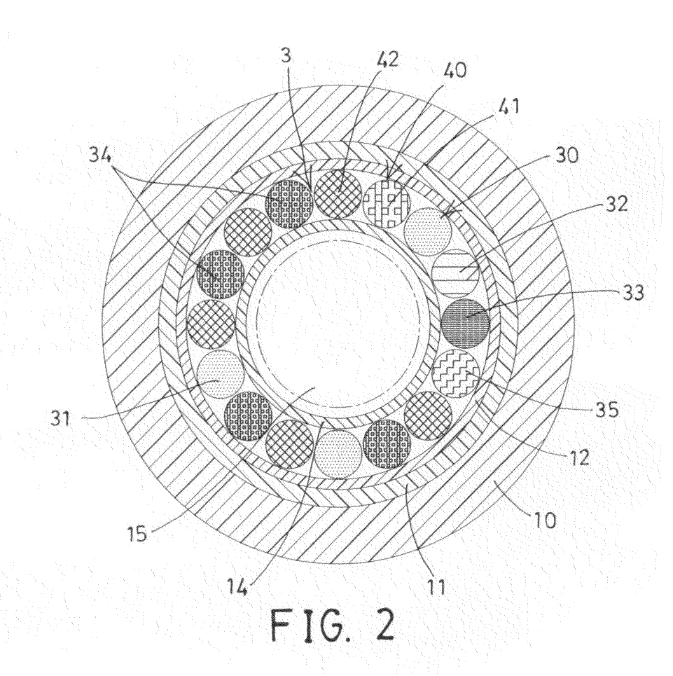

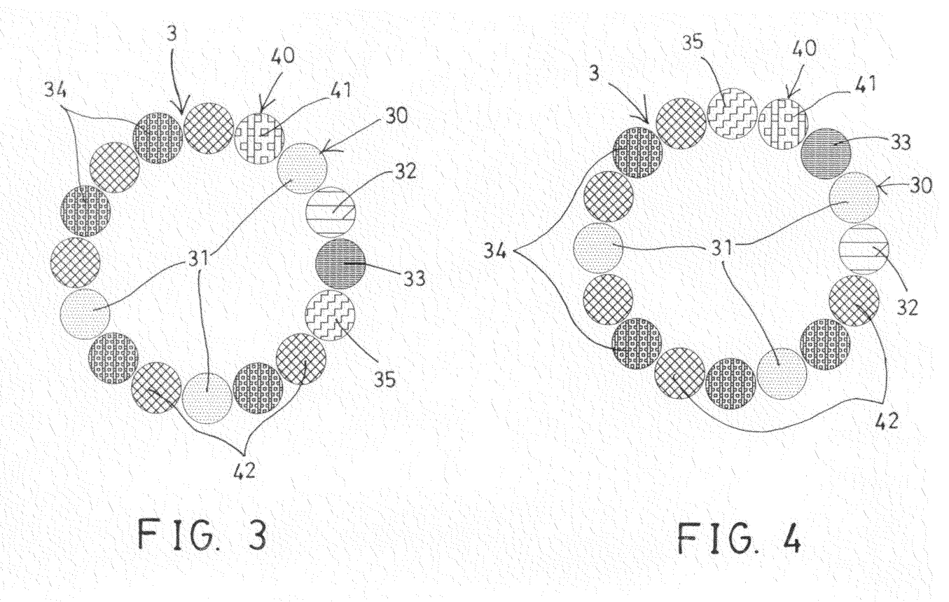

Referring to the drawings, and initially to FIGS. 1 and 2, an actuating cable in accordance with the present invention comprises an outer cover or housing or sheath 10, a reinforcing tubular member 11 disposed or attached or mounted or engaged in the outer sheath 10, a tubular cushioning member 12 disposed or attached or mounted or engaged in the reinforcing tubular member 11, a number of longitudinal lines or ropes or threads or members 3 disposed or attached or mounted or engaged in the cushioning member 12, an inner lubricating bushing 14 disposed or attached or mounted or engaged in the longitudinal members 3 which are disposed or attached or mounted or engaged between the cushioning member 12 and the inner lubricating bushing 14, and an inner wire 15 disposed or attached or mounted or engaged in the inner lubricating bushing 14.

The longitudinal members 3 may include or may be selected from a number of metal elements 30, such as the steel elements 31, the iron elements 32, the aluminum elements 33, the magnesium and aluminum alloy elements 34, the titanic alloy elements 35, . . . , and a number of non-metal elements 40, such as the glass or carbon fiber elements 41, the plastic elements 42, . . . , and the longitudinal metal elements 30 and the longitudinal non-metal elements 40 of the longitudinal members 3 may be adjusted or rearranged in different arrangements or structures for adjusting the arrangement and/or the strength and/or flexibility and/or stiffness of the actuating cable and for suitably actuating or operating the brake devices or the transmission devices of the cycle.

It is to be noted that the longitudinal metal elements 30 and the longitudinal non-metal elements 40 of the longitudinal members 3 may be adjusted or rearranged in different positions or locations for adjusting the strength and/or flexibility and/or stiffness of the actuating cable and for preventing the actuating cable from being bent or twisted or distorted unpredictably, and for suitably actuating or operating the brake devices or the transmission devices of the cycle.

Accordingly, the actuating or operative or pulling cable in accordance with the present invention includes an adjustable structure for adjusting the arrangement and/or the strength and/or flexibility and/or stiffness of the actuating cable and for suitably actuating or operating the brake devices or the transmission devices of the cycle.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. An actuating cable comprising:
an inner bushing,
a tubular cushioning member, and
a plurality of longitudinal members disposed and engaged between the cushioning member and the inner bushing, said longitudinal members including at least one metal element, and at least one non-metal element arrangeable in different positions.

2. The actuating cable as claimed in claim 1, wherein said at least one metal element is selected from a steel element, an iron element, an aluminum element, a magnesium and aluminum alloy element, and a titanic alloy element

3. The actuating cable as claimed in claim 1, wherein said at least one non-metal element is selected from a fiber element, and a plastic element.

4. The actuating cable as claimed in claim 3, wherein said fiber element is selected from a glass fiber, and a carbon fiber.
